(19) United States
(12) Patent Application Publication
(10) Pub. No.: US 2021/0301234 A1
(43) Pub. Date: Sep. 30, 2021

(54) PROCESS FOR THE PRODUCTION OF VODKA

(71) Applicant: ZHS IP Europe Sarl, Nyon (CH)

(72) Inventor: Yuri Schefler, Crans-Montana (CH)

(21) Appl. No.: 17/210,937

(22) Filed: Mar. 24, 2021

(30) Foreign Application Priority Data
Mar. 25, 2020 (EP) 20165669.1

(51) Int. Cl. C12G 3/06; C12G 3/08

(52) U.S. Cl. CPC C12G 3/06; B01D 39/2055; C12G 3/08

(57) ABSTRACT

An improved process is provided to prepare vodka with excellent properties comprising mixing water and ethyl alcohol, treating the mixture with activated coal, filtering, and, optionally, adding sugar. The mixture of water and alcohol is cooled down to a temperature of at least about −18° C., at which temperature the mixture is maintained for at least about 4 hours, particularly at least about 8 hours. The resulting mixture is then cold-filtered at the low-temperature and allowed to gradually adapt to room temperature. The optional sugar is added to the filtrate and the obtained vodka product mixture may be filtered again before bottling. The vodka may comprise an alcoholic strength by volume of between about 37.5 vol % and about 50 vol %, particularly of about 40 vol %, and between about 1 and about 2 g/l sugar.

This application claims priority to EP Application No. 20165669.1, filed Mar. 25, 2020. The entire disclosure of the foregoing application is incorporated by reference herein.

### FIELD OF THE INVENTION

This invention relates generally to the field of vodka production. Specifically, the invention provides novel methods for the production of vodka using cold temperatures.

### BACKGROUND OF THE INVENTION

At present, the widely known method for producing vodka still only uses standard carbon filtering at room temperature of the water-alcohol mixture for vodka production. This known method uses rather simple technology and the vodka produced by this method has relatively poor organoleptic parameters. Moreover, during the process, contaminants may settle in the filter, particularly activated coal, decreasing its activity and adsorbing capabilities. Eventually this may deteriorate the filtration level of the mixture and the obtained vodka may still contain residual traces of fusel oils or other undesired contaminants. Moreover, any flavors of the product may evaporate with time and an alcoholic aftertaste may manifest itself in the odor and taste. In view of the foregoing, it is clear that improved methods for producing vodka are needed.

### SUMMARY OF THE INVENTION

In accordance with the instant invention, methods for the production of vodka are provided. In certain embodiments, the method comprises cooling and maintaining a mixture of water and alcohol at a temperature of at least about −18° C. or lower for at least about 4 hours (e.g., for at least 8 hours) prior to cold-filtering the mixture of water and alcohol. In certain embodiments, the mixture of water and alcohol is maintained at a temperature of about −18° C. (e.g., ±1° C.) prior to cold-filtering. In certain embodiments, the mixture of water and alcohol has an alcoholic strength by volume of between about 37.5% and about 50% (e.g., about 40%). In certain embodiments, the water used for preparation of the mixture has an alkalinity of less than 3 meq/l. In certain embodiments, the methods of the instant invention further comprise treating the mixture of alcohol and water with activated carbon (e.g., over a column comprising activated carbon) prior to maintenance at cold temperature. In certain embodiments, the methods of the instant invention further comprise adding sugar to the mixture after cold-filtering (e.g., to between about 1 and about 2 g/l, particularly to about 1.2 g/l). In certain embodiments, the cold-filtering occurs at about −18° C. temperature or substantially at about −18° C. temperature (e.g., within about 6-10 degrees of the cold maintenance step). In certain embodiments, the cold-filtering comprises filtering the mixture of water and alcohol over a carbon filter (e.g., a Z-carbon filter and/or a carbon filter comprising activated carbon). In certain embodiments, the methods of the instant invention further comprise raising the temperature of the mixture of water and alcohol to room temperature after cold-filtering (e.g., by maintaining the mixture in a non-isolated tank) and, optionally, filtering (e.g., over a series of micro-filters) at room temperature prior to bottling.

### BRIEF DESCRIPTION OF THE DRAWINGS

FIG. 1 provides a graph of the absorption (A) at 220 nm of Batches A (−4° C., 4 hours), B (−10° C., 4 hours), C (−15° C., 4 hours), D (−18° C., 4 hours), and E (−18° C., 8 hours). Curve S is fitted for the data at −4° C., −10° C., and −15° C.

FIG. 2 provides a graph of the absorption (A) at 230 nm of Batches A (−4° C., 4 hours), B (−10° C., 4 hours), C (−15° C., 4 hours), D (−18° C., 4 hours), and E (−18° C., 8 hours). Curve S is fitted for the data at −4° C., −10° C., and −15° C.

FIG. 3 provides a graph of the absorption (A) at 240 nm of Batches A (−4° C., 4 hours), B (−10° C., 4 hours), C (−15° C., 4 hours), D (−18° C., 4 hours), and E (−18° C., 8 hours). Curve S is fitted for the data at −4° C., −10° C., and −15° C.

FIG. 4 provides a graph of the absorption (A) at 270 nm of Batches A (−4° C., 4 hours), B (−10° C., 4 hours), C (−15° C., 4 hours), D (−18° C., 4 hours), and E (−18° C., 8 hours). Curve S is fitted for the data at −4° C., −10° C., and −15° C.

FIG. 5 provides a graph of the translucency (T) at 364 nm of Batches A (−4° C., 4 hours), B (−10° C., 4 hours), C (−15° C., 4 hours), D (−18° C., 4 hours), and E (−18° C., 8 hours). Curve S is fitted for the data at −4° C., −10° C., and −15° C.

### DETAILED DESCRIPTION OF THE INVENTION

The present invention relates to a process for the production of vodka comprising mixing water and alcohol to obtain a water-alcohol mixture, cooling down the mixture of water and alcohol to a temperature at least about −18° C., and maintaining the mixture at the lower temperature for several hours before cold-filtering the mixture. Herein, the expression “alcohol” is used to denote ethyl alcohol (ethanol), unless explicitly indicated otherwise or evident from the context.

European Patent No. 1,549,734 provides a method of producing vodka which includes a cold-filtration step at a temperature of −10° C. to −15° C. after the alcohol-water mixture was maintained at this low temperature for several hours. This process allows fusel oils and other impurities to settle and possibly to crystalize which significantly enhances the subsequent filtration step. As a result, the final vodka-product is substantially void of any impurities that may affect its organoleptic properties, which manifest itself a very pleasant and smooth taste.

The present invention has inter alia for its objective to further improve the latter process for producing vodka of even higher quality and unprecedented taste.

In order to achieve this objective, a process for producing vodka in accordance with the instant invention is provided wherein the alcohol-water mixture is cooled down to a temperature of at least about −18° C. and maintained at this temperature for at least 4 hours (particularly, for at least about 8 hours) prior to cold-filtering the mixture. In certain embodiment, the cold-filtering is performed substantially at the same low temperature, particularly over a carbon filter, such as a Z-carbon filter.

Profound cooling of the water-alcohol mixture to −18° C. or less considerably increases the density of the water-alcohol mixture. Without being bound by theory, this can lead to the formation of a fine crystalline film comprising a mixture of aldehydes and other micro-contaminations on walls of the cooler. Filtration at such low temperature better purifies the water-alcohol mixture while not destroying the molecular system of the water-alcohol formed from cooling of the water-alcohol mixture. The same aim is attained by gradual natural warming of the mixture after filtration with an appropriate time lag.

As seen in the Example, spectrometric absorption and translucency tests have shown that the vodka that is produced by the methods of the instant invention, after having been maintained at about 4 hours at a temperature of at least −18° C. before cold-filtering, shows a sudden, significant, and unexpectedly superior further drop of the impurity level in the product. As a result, the final water/alcohol mixture is almost void of contamination that could otherwise harm the organoleptic properties of the final product.

In certain embodiments, the method according to the instant invention is characterized in that the alcohol-water mixture is maintained at approximately −18° C. or less for at least about 4 hours, particularly for at least about 8 hours, before cold-filtering the mixture. Although cooling down to the minimal temperature for 4 hours already results in a significant improvement over the prior art, maintaining the water/alcohol mixture at least 4 hours longer provides an even further level of purity. In certain embodiments, the alcohol-water mixture may be cooled by passage through a heat exchanger. In certain embodiments, the alcohol-water mixture is maintained at the lower temperature is a heat isolated tank.

In certain embodiments, the alcohol-water mixtures of the instant invention have an alcoholic strength by volume of between about 37.5 vol % and about 50 vol %, particularly of about 40 vol %.

The water for the water-alcohol mixture may be purified, particularly by a reverse osmosis method. In certain embodiments, water for the water-alcohol mixture is obtained by treating softened water (optionally deironed) by the method of reverse osmosis, normalized by the alkalinity parameter of less than 3 meq/l (e.g., within about 2-3 meq/l). The term “alkalinity characteristic” is defined as volume in ml of hydrochloric acid with a concentration 0.1 M (i.e., 0.1 Mol/l) of HCl used for titration of 100 ml sample.

In certain embodiments, the water-alcohol mixture may be treated with activated coal/charcoal/carbon, particularly prior to cold temperature treatment. For example, the water-alcohol mixture may be passed through a column of activated coal/charcoal/carbon. In certain embodiments, the water-alcohol mixture is treated with activated coal in a column, particularly at a filtration rate of about 30 to about 50 decaliters/hour.

In certain embodiments, the methods of the instant invention further comprise adapting the filtrate to room temperature. For example, the filtrate may be transferred or pumped to a tank, particularly a non-isolated tank, until room temperature has been attained. Normally, room temperature will be in the range of between about 18° C. and about 25° C. In certain embodiments, the method further comprises filtering (e.g., over a micro-filter or a series of micro-filters) the resulting mixture at room temperature before bottling, particularly immediately before bottling.

The methods of the instant invention may comprise treating the produced vodka product to provide an elegant taste and/or distinct organoleptic character. In certain embodiments, the method further comprises adding sugar (e.g., between about 1 and about 2 g/l, particularly about 1.2 g/l) to the mixture after filtration. In certain embodiments, the method comprises adding one or more additives to the mixture after filtration, particularly additives permitted under prevailing EU and/or US regulations. For example, the additives may be taken from the group of sugar (e.g., sugar syrup) and natural flavoring compounds, such as those present in the distillate and/or obtained from the fermented raw materials. Such additives may provide a distinctive taste and nose to the vodka that distinguishes the product over other vodkas.

In certain embodiments of the instant invention, the final product comprises:
a percentage of absolute alcohol in water of between about 37.5 vol % and about 50 vol %, particularly about 40 vol % absolute alcohol; and
between about 1 and about 2 g/l sugar, particularly about 1.2 g/l sugar.
   Due to the unprecedented quality of the starting alcohol, merely adding sugar can slightly refine the taste and character of the emanations and characteristics of the vodka product.

In order to remove any residual contaminations in the final product, the methods of the instant invention may further comprise filtering (e.g., over a micro-filter or a series of micro-filters) the obtained mixture (e.g., at room temperature) prior to bottling, particularly immediately before bottling.

The following example is provided to illustrate various embodiments of the present invention. The example is not intended to limit the invention in any way.

### Example

A vodka product was prepared using ethyl alcohol (ethanol; “Lux”) and water obtained by treating softened water by the method of reverse osmosis, normalized by a parameter of alkalinity within 2-3 meq/l. Alcohol or spirit “Lux” has been described in the State Standard of the Russian Federation no. GOST 5962-2013. Ethyl alcohol “Lux” may be produced from various sorts of grains and/or mix of grain and potatoes. A volume of starch in the mix preferably does not exceed 60% for production of ethyl alcohol “Lux”.

In a mixing tank, the alcohol and water were mixed to obtain a mixture of about 40 vol % absolute alcohol content. This mixture was passed through a column with activated coal at a filtration rate of 30-50 decaliters/hour. The filtered water-alcohol mixture was then passed through a heat exchanger to decrease its temperature. The cooled mixture was then kept in the heat isolated tank for a duration of several hours. In this manner, five batches were formed. Three batches (A, B, C) resemble a prior art production process and two batches (D, E) are in accordance with the present invention. These batches are as follows:

TABLE 1
Batch processes

| | | |
|---|---|---|
| Batch | Cooled Down to | Settled for |

| | | | |
|---|---|---|---|
| A | −4° | C. | 4 hours |
| B | −10° | C. | 4 hours |
| C | −15° | C. | 4 hours |
| D | −18° | C. | 4 hours |
| E | −18° | C. | 8 hours |

After having settled at the indicated temperature for the indicated lengths of time, the cold mixture was filtered through a Z-carbon filter. The temperature of the mixture typically increased on the order of between 6 and 10 degrees. Finally, the obtained filtrate was pumped to a non-isolated tank to allow the mixture to gradually attain room temperature at between 18° C. and 25° C.

All batches of the obtained water-alcohol mixture were finished by merely adding the same amount of sugar syrup with 65.8% Brix (mass concentration of sugar in syrup). The obtained composition was kept for one to five hours and then the produced vodka was consecutively filtered through a series of micro filters before bottling.

The batches A-E were subjected to a series of tests. In order to analyze the chemical purity of the different batches, samples thereof were taken and the optical absorption (A) was measured at a wavelength of 220 nm, 230 nm, 240 nm and 270 nm, pursuant to the methodology as stated in EU regulation 625/2003 Annex IV, method 12. Moreover, the optical translucency (T) was measured at 364 nm. These wavelengths correspond to those at which absorption may be expected by the suspected impurities in the samples. The results of these absorption/translucency tests are shown in Tables 2 and 3.

TABLE 2
Absorbance of Batches

| | Absorption (A) | | | |
|---|---|---|---|---|
| Sample | 220 nm | 230 nm | 240 nm | 270 nm |
| A (−4° C., 4 hours) | 0.2295 | 0.1532 | 0.1204 | 0.0916 |
| B (−10° C., 4 hours) | 0.2014 | 0.1344 | 0.0969 | 0.0687 |
| C (−15° C., 4 hours) | 0.1990 | 0.1317 | 0.0947 | 0.0675 |
| D (−18° C., 4 hours) | 0.1815 | 0.1214 | 0.0856 | 0.0599 |
| E (−18° C., 8 hours) | 0.1794 | 0.1143 | 0.0824 | 0.0595 |

TABLE 3
Translucency of Batches

| | Translucency (T) |
|---|---|
| Sample | 364 nm |
| A (−4° C., 4 hours) | 89.59 |
| B (−10° C., 4 hours) | 89.81 |
| C (−15° C., 4 hours) | 89.76 |
| D (−18° C., 4 hours) | 89.95 |
| E (−18° C., 8 hours) | 90.01 |

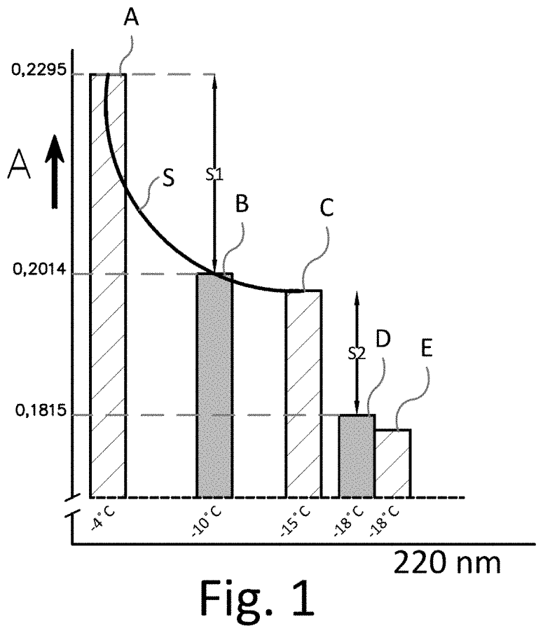

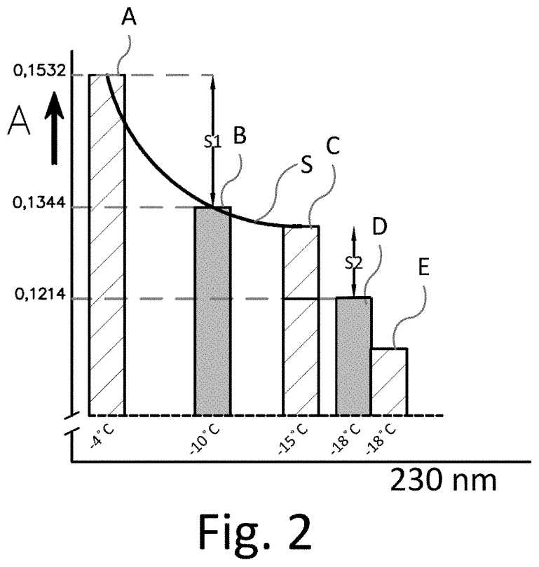

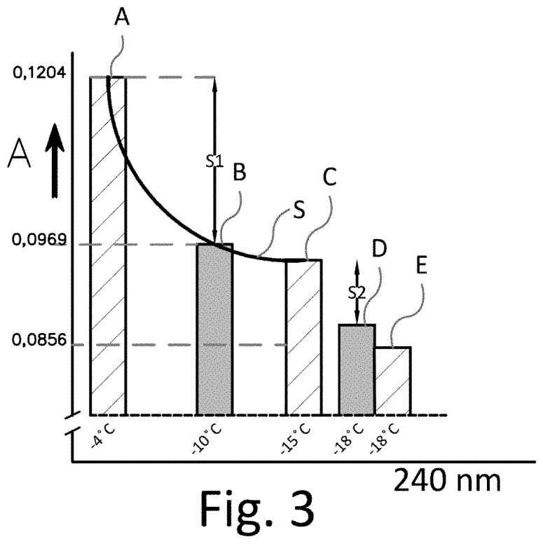

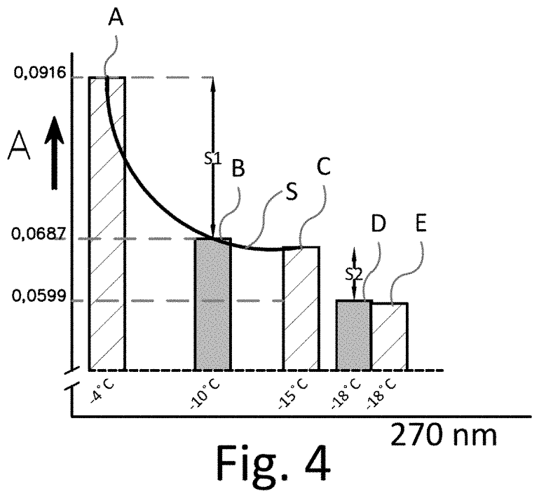

These results have also been depicted in the graphs of FIGS. 1-5. As seen in FIGS. 1-4, the absorption drops by a step S1 if the alcohol-water mixture was cold-filtered at a temperature between −10° C. and −15° C. compared to cold filtering at the higher temperature of −4° C. Within the range of −10° C. and −15° C., there is almost no change in the absorption that was measured (see, e.g., FIGS. 1-4). Based on these results, further lowering of the temperature below −15° C. would not be expected to result in a substantial further improvement. This trend has been illustrated in FIGS. 1-4 by curve S, which is fitted through the points at −4° C. −10° C. and −15° C. However, in stark contrast to curve S and the data provided at −4° C. −10° C. and −15° C., FIGS. 1-4 and Table 2 demonstrate an unexpectedly superior further drop in the absorptions when the alcohol-water mixture was maintained at −18° C. This unexpected further drop is depicted by step S2 is FIGS. 1-4. This unexpected drop in absorbance at −18° C. indicates a significantly and substantially better purity of the final product.

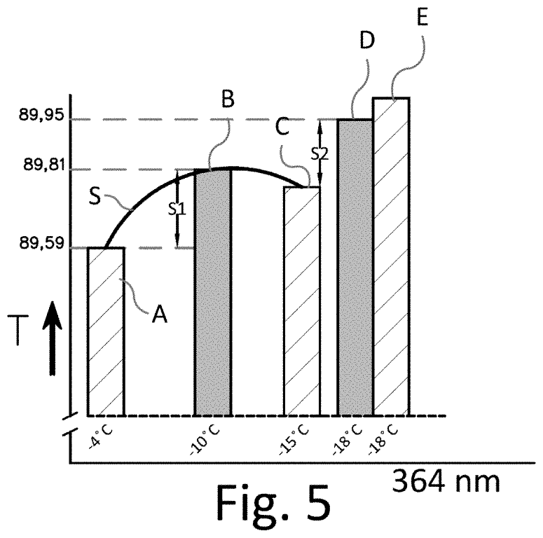

A similar effect is noticed regarding the translucency at 364 nm, as shown in Table 3 and FIG. 5. Indeed, as seen in FIG. 5, translucency at 364 nm actually decreased (worsened) when the temperature was dropped from −10° C. and −15° C. Surprisingly, further dropping the temperature to −18° C. significantly increased the translucency at 364 nm (see, e.g., S2 in FIG. 5).

In addition to the above, the data provided in FIGS. 1-5 and Tables 2 and 3 also shows that maintaining the product for more than four hours (e.g., 8 hours) at −18° C. results in a further improvement of the purity of the product (see Batch E).

These chemical measurements were confirmed by a professional tasting panel of ten tasters that provided the following tasting notes and ratings with respect to samples from the batches A-E that were produced.

TABLE 4
Tasting Results

| | Average | |
|---|---|---|
| Sample | Rating | Description of the Product |
| Reference Sample | 9.31 | Slightly pronounced, clean aroma of alcohol, |
| (no cold-filtering) | | non-homogeneous taste, alcoholic aftertaste. |
| | | Pronounced aroma of alcohol, slightly sweet |
| | | taste, slightly pungent, clean after-taste. |
| | | Strongly pronounced aroma of alcohol with a |
| | | pungent after-taste. Transparent, clear, shiny, |
| | | clean aroma, characteristic of vodka, clean |
| | | taste with a slight bite. Characteristic aroma, |
| | | alcoholic, alcoholic taste, characteristic with a |
| | | bite in the after-taste. Aroma of alcohol, |
| | | pungent after-taste, prolonged. |
| A (−4° C., 4 hours) | 9.71 | Papery aroma note + alcohol, rounded taste, |
| | | after-taste dry too. Aroma close to neutral, |
| | | medium-mild taste, but with a longer, |
| | | alcoholic after-taste. Samples A-E have |
| | | clean, clear color, clean aroma, characteristic |
| | | of vodka, without additional notes, taste also |
| | | without additional notes, a bite characteristic |
| | | of vodka, short after-taste. Very neutral |
| | | aroma, mild, sweet taste, short after-taste. |
| | | Mild, clean aroma, clean taste, with a small |
| | | bite in the after-taste. Warm aroma, slightly |
| | | sweet, smooth taste, with a bite in the after- |
| | | taste. Empty aroma, sharper taste, longer |
| | | after-taste. |
| B (−10° C., 4 hours) | 9.70 | Strong aroma of alcohol, rather sharp notes of |
| | | alcohol, bitter. Aroma close to neutral, taste |
| | | medium-mild, a slight bite in the after-taste. |
| | | Pronounced aroma of vodka, mild taste, with |
| | | a slight sharpness. Clean aroma, |
| | | comparatively less intense, a slight sharpness |
| | | in the taste in the finish. Aroma more intense, |
| | | taste slightly sweet, a more lasting sharpness |
| | | in the after-taste. More pungent taste, longer |
| | | after-taste. |
| C (−15° C., 4 hours) | 9.73 | Aroma close to neutral, corny notes, taste |
| | | rounded, smooth, an after-taste characteristic |
| | | of vodka. Neutral aroma, mild, rounded taste, |
| | | fiery after-taste. Pronounced aroma, after- |
| | | taste with a slight bite. Less intense aroma |
| | | too, very similar to S.4, with a slight, sharp |
| | | note in the after-taste. Aroma less warm, of |
| | | medium intensity, very thick, mild, sweet |
| | | taste, short, clean after-taste. Clean, well- |
| | | balanced taste. |
| D (−18° C., 4 hours) | 9.74 | A slight aroma of vodka with the notes of |
| | | green, fresh grass, taste of vodka with a sharp |
| | | after-taste. Neutral aroma, mild, sweet taste, |
| | | after-taste with a slight bite. Light aroma of |
| | | vodka, mild, well-balanced, rounded taste. |
| | | Very light, unobtrusive aroma, slight |
| | | sweetness in the beginning, then a bit |
| | | pungent, but seemed to have a rich, well- |
| | | balanced taste. Aroma similar to S.5, sweet, |
| | | mild taste, with more pronounced bite. |
| | | Aroma stronger, sharper, clean taste, a little |
| | | watery. |
| E (−18° C., 8 hours) | 9.77 | Aroma close to neutral to the aroma of vodka, |
| | | clean taste, with a slightly viscous (extract- |
| | | like) hint, with a sharp bite, clean after-taste. |
| | | Neutral aroma, slightly sweet, rounded taste, |
| | | short, clean, a bit pungent after-taste. Liked it |
| | | best of all, short after-taste. Neutral aroma, |
| | | mild taste, slightly pungent. Clean, almost |
| | | non-existent aroma of vodka (sweetness), |
| | | close to sample D: sweetness present in the |
| | | beginning, then pungent (fiery, clean). The |
| | | most neutral aroma of all, alcohol is felt less, |
| | | taste with the least sweetness, mild, the after- |
| | | taste seems the shortest, mildest of all. |
| | | Sweeter taste. Typical, very slight aroma, |
| | | typical, very clean, light taste, the most |
| | | neutral and mild sample. |

The tasting method was performed according to the GOST 33817-2016 (10 point system) standard to evaluate the organoleptic properties of the different samples. This tasting provides convincing evidence that cold-filtering at −18° C. delivers a superb product. Allowing the product to settle for more than four hours, especially for eight hours, before cold-filtering at −18° C. or below delivers a vodka product of unprecedented quality, purity and taste.

Several publications and patent documents are cited in the foregoing specification in order to more fully describe the state of the art to which this invention pertains. The disclosure of each of these citations is incorporated by reference herein.

Although the invention has been described and substantiated with reference to merely a few explanatory comparative examples it will be appreciated that the invention is by no means limited to those examples. On the contrary, many more embodiments and variations are feasible and within the reach of a skilled person without departing from the true scope and spirit of the present invention.

What is claimed is:

1. A method for the production of vodka, said method comprising mixing water and alcohol to obtain a water and alcohol mixture and cooling said mixture of water and alcohol to a temperature of at least about −18° C. and maintaining said mixture of water and alcohol at a temperature of at least about −18° C. for at least about 4 hours prior to cold-filtering said mixture of water and alcohol, thereby producing said vodka.

2. The method of claim 1, wherein said mixture of water and alcohol is maintained at a temperature of at least about −18° C. for at least about 8 hours prior to cold-filtering.

3. The method of claim 1, wherein said mixture of water and alcohol has an alcoholic strength by volume of between about 37.5% and about 50%.

4. The method of claim 3, wherein said mixture of water and alcohol has an alcoholic strength by volume of about 40%.

5. The method of claim 1, wherein said method further comprises adding sugar to the mixture after said cold-filtering.

6. The method of claim 5, wherein said sugar is added to between about 1 and about 2 g/l.

7. The method of claim 6, wherein said sugar is added to about 1.2 g/l.

8. The method of claim 1, wherein said cold-filtering occurs substantially at about −18° C. temperature.

9. The method of claim 1, wherein said cold-filtering comprises filtering the mixture of water and alcohol over a carbon filter.

10. The method of claim 9, wherein said carbon filter is a Z-carbon filter.

11. The method of claim 9, wherein said carbon filter comprises activated carbon.

12. The method of claim 1, further comprising raising the temperature of the mixture of water and alcohol to room temperature after said cold-filtering.

13. The method of claim 12, wherein the room temperature mixture is filtered at room temperature prior to bottling.

14. The method of claim 13, wherein said filtering at room temperature is performed over a series of micro-filters.

15. The method of claim 12, wherein the temperature of the mixture of water and alcohol is raised to room temperature by maintaining the mixture in a non-isolated tank.

16. The method of claim 12, wherein said mixture of water and alcohol is maintained at a temperature of at least −18° C. in an isolated tank and wherein said mixture is allowed to gradually adapt to room temperature in a non-isolated tank after pumping said mixture from said isolated tank to said non-isolated tank.

17. The method of claim 1, wherein said water has an alkalinity of less than 3 meq/l.

18. The method of claim 1, wherein said method further comprises passing the mixture of alcohol and water through an activated carbon column prior to maintenance at cold temperature.

19. The method of claim 1, wherein said mixture of water and alcohol is maintained at about −18° C.
